(19) United States
(12) Patent Application Publication
(10) Pub. No.: US 2025/0278929 A1
(43) Pub. Date: Sep. 4, 2025

(54) DEVICE, A DATASTRUCTURE, A METHOD FOR DETERMINING A PREDICTION INTERVAL FOR A COORDINATE OF A BOUNDING BOX, IN PARTICULAR FOR CHECKING WHETHER AN OBJECT DETECTOR OPERATES SAFELY OR NOT, PREFERABLY FOR OPERATING AN IN PARTICULAR AUTONOMOUS VEHICLE

(71) Applicant: Robert Bosch GmbH, Stuttgart (DE)

(72) Inventors: Alexander Timans, Amsterdam (NL); Christoph-Nikolas Straehle, Weil Der Stadt (DE); Kaspar Sakmann, Stuttgart (DE); Eric Nalisnick, Ellicott City, MD (US)

(21) Appl. No.: 19/062,296

(22) Filed: Feb. 25, 2025

(30) Foreign Application Priority Data
Feb. 29, 2024 (EP) 24 16 0622.7

(51) Int. Cl. G06V 10/776; G06V 10/25; G06V 10/764; G06V 20/56

(52) U.S. Cl. CPC G06V 10/776; G06V 10/25; G06V 10/764; G06V 20/56

(57) ABSTRACT

A device, data structure, and method for determining a prediction interval for a coordinate of a bounding box, for checking whether an object detector operates safely or not. The method includes providing calibration data and a test sample, the calibration data including digital images that are associated with a respective ground truth bounding box coordinate and class label, the test sample including a digital image; determining, with the object detector, a predicted box coordinate for the box coordinate depending on the test sample, determining, depending on the calibration data, conformal label quantiles for the respective classes and conformal box coordinate quantiles for the respective box coordinates, selecting, depending on the conformal label quantiles, a conformal box coordinate quantile for the box coordinate, determining the conformal box coordinate prediction interval for the box coordinate depending on the conformal box quantile for the box coordinate.

### CROSS REFERENCE

The present application claims the benefit under 35 U.S.C. § 119 of European Patent Application No. EP 24 16 0622.7 filed on Feb. 29, 2024, which is expressly incorporated herein by reference in its entirety.

### FIELD

The present invention relates to a device, a datastructure, and a method for determining a prediction interval for a coordinate of a bounding box, in particular for checking whether an object detector operates safely or not, preferably for operating an in particular autonomous vehicle.

### SUMMARY

A device, a datastructure, and a method according to the present invention provide a prediction interval with a guarantee for the correctness of the bounding box coordinate within the prediction interval.

### SUMMARY

According to an example embodiment of the present invention, the method for determining a prediction interval for a coordinate of a bounding box, in particular for checking whether an object detector operates safely or not, preferably for operating an in particular autonomous vehicle, comprises providing calibration data and a test sample, wherein the calibration data comprises digital images that are associated with a respective ground truth bounding box coordinate and class label, wherein the test sample comprises a digital image, determining, in particular with the object detector, a predicted box coordinate for the box coordinate depending on the digital image of the test sample, determining, depending on the calibration data, conformal label quantiles for the respective classes and conformal box coordinate quantiles for the respective box coordinates, selecting, depending on the conformal label quantiles, a conformal box coordinate quantile for the box coordinate from the conformal box coordinate quantiles for the box coordinate, determining the conformal box coordinate prediction interval for the box coordinate depending on the conformal box quantile for the box coordinate.

According to an example embodiment of the present invention, selecting the conformal box coordinate quantile for the box coordinate may comprise determining a conformal label set depending on the conformal label quantiles, wherein the conformal label set comprises a subset of class labels of the calibration data, and selecting the largest of the conformal box coordinate quantiles over the classes in the conformal label set as the box coordinate quantile for the box coordinate. This conformal method works independent of any classes that the object detector may assign.

According to an example embodiment of the present invention, for a class specific prediction interval, the calibration data comprises the digital images associated with a respective class of a set of classes, wherein the test sample comprises the digital image in particular associated with a class of the set of classes, wherein the method comprises determining, in particular with the object detector, a predicted class for the predicted box coordinate, wherein selecting the conformal box coordinate quantile for the box coordinate comprises determining, depending on the calibration data, for the classes in the set of classes a respective conformal box coordinate quantile that is associated with the respective class, determining, depending on the calibration data, a conformal label set comprising a subset of the classes, and selecting the largest of the conformal box coordinate quantiles that is associated to a class in the subset as the conformal box coordinate quantile for the box coordinate. This conformal method works best when the object detector comprises a calibrated classifier for the classes.

According to an example embodiment of the present invention, determining the conformal label set comprising the subset of the classes may comprise determining predicted class labels that are associated with a respective probability that the respective predicted class label labels correctly, determining for the classes in the set of classes, in particular with a probabilistic classifier and a scoring function for the class, a respective conformal label quantile depending on the digital images of the calibration data, and selecting the subset in descending probability order from the predicted class labels such that a coverage according to the conformal label quantile is achieved. This means that the conformal box coordinate quantiles of the classes that are more likely the correct class than other classes are used to determine the prediction interval.

According to an example embodiment of the present invention, the method may comprise determining that the object detector operates unsafely when the predicted coordinate is outside of the prediction interval.

According to an example embodiment of the present invention, the method may comprise determining, in particular with the object detector, the predicted coordinates of the bounding box, determining the prediction interval for the respective predicted coordinates, and determining that the object detector operates safely when the predicted coordinates are within the prediction interval, or determining that the object detector operates unsafely when the predicted coordinates are outside of the prediction interval.

The prediction interval can be used to for example safely operate autonomous vehicles.

According to an example embodiment of the present invention, the method may comprise operating an in particular autonomous vehicle depending on the bounding box coordinate, when it is detected that the object detector operates safely, and otherwise not operating an in particular autonomous vehicle depending on the bounding box coordinate.

According to a use case, the vehicle has to plan a trajectory around other traffic participants. The prediction interval for the bounding box coordinate allows to plan with a bounding box having a statistical guaranty on the size and position of an object, e.g., another traffic participants, in the bounding box. The vehicle for example ignores bounding box coordinates for that an unsafe operation of the object detector is detected. The vehicle for example uses bounding box coordinates for that a safe operation of the object detector is detected. Thus the vehicle plans a safer trajectory.

According to an example embodiment of the present invention, the method may comprise operating an in particular autonomous vehicle depending on the bounding box coordinate or depending on the predicted class, when it is detected that the object detector operates safely, and otherwise not operating an in particular autonomous vehicle depending on the bounding box coordinate or depending on the predicted class.

This means, the class specific prediction interval is used for operating the vehicle.

The device for determining a prediction interval for a coordinate of a bounding box, in particular for checking whether an object detector operates safely or not, preferably for operating an in particular autonomous vehicle, wherein the device comprises at least one processor and at least one memory, wherein the at least one memory is configured to store instructions that, when executed by the at least one processor cause the device to execute the method of the present invention.

A computer program may be provided, wherein the computer program comprises computer readable instructions that, when executed by a computer, cause the computer to execute the method of the present invention.

According to an example embodiment of the present invention, the data structure, in particular a computer implemented data structure, comprises at least one data field for calibration data, and for a test sample, wherein the calibration data comprises digital images associated with a respective ground truth bounding box coordinate and class label, wherein the test sample comprises a digital image, wherein the data structure comprises at least one data field for a predicted box coordinate, for conformal label quantiles for the respective classes and conformal box coordinate quantiles for the respective box coordinates, for a conformal box coordinate quantile selected from the conformal box coordinate quantiles depending on the conformal label quantiles, and for a conformal box coordinate prediction interval.

The data structure may comprise at least one data field for a class associated with a respective digital image of the calibration data, preferably at least one data field for a class associated with the digital image of the test sample, at least one data field for a predicted class for the predicted box coordinate, for a conformal box coordinate quantile that is associated with a respective class of the set of classes, and for a conformal label set comprising a subset of the classes.

Further advantageous embodiments of the present invention are derived from the following description and the figures.

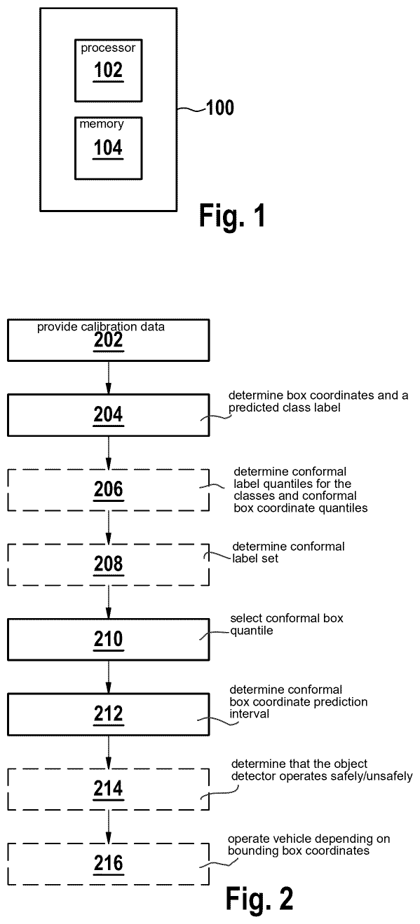

FIG. 1 depicts a device for determining a prediction interval for a coordinate of a bounding box, in particular for checking whether an object detector operates safely or not, preferably for operating an in particular autonomous vehicle, according to an example embodiment of the present invention.

FIG. 2 depicts a flowchart with steps of a method for determining the prediction interval for the coordinate of the bounding box, in particular for checking whether the object detector operates safely or not, preferably for operating the in particular autonomous vehicle, according to an example embodiment of the present invention.

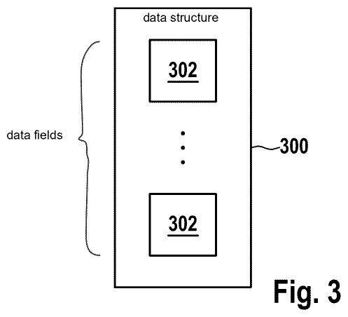

FIG. 3 schematically depicts a data structure, according to an example embodiment of the present invention.

### DETAILED DESCRIPTION OF EXAMPLE EMBODIMENTS

FIG. 1 schematically depicts a device 100 for determining a prediction interval for a coordinate of a bounding box.

The device may be configured for checking whether an object detector operates safely or not.

The device may be configured for checking whether an object detector operates safely or not for operating an in particular autonomous vehicle.

The autonomous vehicle may comprise the device 100.

The device 100 may be configured for operating the autonomous vehicle.

According to a use case, the device 100 is configured to plan a trajectory of the vehicle around other traffic participants. According to a use case, the device 100 is configured to output instructions for actuators of the vehicle, e.g., an engine and/or a steering system and/or a brake system of the vehicle, in order to drive the vehicle along the trajectory.

The object detector may be configured to output multiple bounding boxes comprising the other traffic participant. The device 100 may be configured to plan the trajectory depending on the bounding box. The object detector may be configured to output a class for the bounding box that labels the class of the other traffic participant. The device 100 may be configured to plan the trajectory depending on the class.

The device 100 comprises at least one processor 102 and at least one memory 104.

The at least one memory 104 is configured to store instructions that, when executed by the at least one processor 102 cause the device 100 to execute a method for determining a prediction interval for a coordinate of a bounding box.

The method may be a method for determining the prediction interval for the coordinate of a bounding box for checking whether an object detector \hat{f} operates safely or not.

The method may be a method for checking whether the object detector \hat{f} operates safely or not for operating the in particular autonomous vehicle.

FIG. 2 depicts a flow chart with steps of the method.

The method comprises a step 200.

The step 200 comprises providing labels l∈{1, . . . K} representing object's class labels of a set of classes [symbol] .

The method comprises a step 202.

The step 202 comprises providing calibration data D_{cal}={Xᵢ, Yᵢ}ᵢ₌₁ⁿ˜P_{XY} associated with the respective ground truth bounding box coordinates and an unseen test sample (Xₙ₊₁, Yₙ₊₁), wherein X∈ [symbol] ^{H×W×D} denotes a digital image, where H is the height, W is the width, and D is the channel depth of the digital image, wherein Y denotes the ground truth bounding boxes coordinates and their classes.

The method comprises a step 204.

The step 204 comprises determining box coordinates ĉₙ₊₁^{k} and a predicted class label \hat{l}ₙ₊₁ for the bounding box coordinates ĉₙ₊₁^{k} depending on the digital image Xₙ₊₁ of the unseen test sample (Xₙ₊₁, Yₙ₊₁), in particular with an object detector \hat{f}(Xₙ₊₁)

$$( {\hat{c}}_{n + 1}^{k} , {\hat{l}}_{n + 1} ) = \hat{f} ( {X}_{n + 1} )$$

For a bounding box that is defined by m coordinates k=1, . . . m, the object detector \hat{f}(Xₙ₊₁) is for example configured to output a mean coordinate prediction ĉₙ₊₁^{k} for the k-th coordinate of the bounding box.

The predicted class label \hat{l}ₙ₊₁ is a prediction of the object detector \hat{f} for the object's class labels l∈{1, . . . K}.

The step 204 may comprise determining, in particular with the object detector \hat{f}(Xₙ₊₁), the predicted coordinates ĉₙ₊₁^{k}, k=1, . . . m, of the bounding box in the digital image Xₙ₊₁ of the test sample.

The method comprises a step 206.

The step 206 comprises determining conformal label quantiles \hat{q}_{L}^{y} for the classes y∈ [symbol] and conformal box coordinate quantiles \hat{q}_{B}^{k,y} for the k coordinates k=1, . . . , m and the classes y∈ [symbol] depending on the calibration data D_{cal}. \hat{q}_{B}^{k,y} denotes the quantile of the k-th coordinate for class y.

According to an example, the respective per-class conformal label quantile \hat{q}_{L}^{y} is determined with a probabilistic classifier \hat{f}_{L}(X) and a scoring function s(\hat{f}_{L}(X), y)=1−\hat{π}_{y}(x) for the class y∈ [symbol] depending on the digital image X, wherein \hat{π}_{y}(x) denotes the probability that a digital image x is correctly classified in class y.

The method optionally comprises a step 208.

The optional step 208 comprises determining a conformal label set Ĉ_{L}(Xₙ₊₁) depending on the conformal label quantiles \hat{q}_{L}^{y} for the classes y∈ [symbol] :

$${\hat{C}}_{L} ( {X}_{n + 1} ) = \{ y ∈ Y : {\hat{π}}_{y} ( {X}_{n + 1} ) \geq 1 - {\hat{q}}_{L}^{y} \}$$

The conformal label set Ĉ_{L}(Xₙ₊₁) comprises a subset of the classes. The subset is selected in descending probability order from the predicted class labels such that a coverage according to the conformal label quantile \hat{q}_{L}^{y} is achieved.

Assuming that the predicted class labels consist of the highest probability class for every sample, i.e.,

$${\hat{C}}_{L} ( {X}_{n + 1} ) = \{ {y}^{*} : {\hat{π}}_{{y}^{*}} ( {X}_{n + 1} ) = {max}_{y ∈ \{ 1 , … , k \}} {\hat{π}}_{y} ( {X}_{n + 1} ) \} ,$$

singleton sets Ĉ_{L}(Xₙ₊₁) are determined that come without nominal guarantees. This means the empirical coverage performance relies fully on the classifier's accuracy.

Assuming that the probabilistic classifier \hat{f}_{L}(X) may be calibrated, such that \hat{π}_{y}(x)=π_{y}(x)∀y∈ [symbol] , \hat{π}_{y}(x) may be sorted in descending order until the probability mass 1−α_{L} is reached, wherein α_{L} is a parameter set e.g. to achieve 90% coverage or any other coverage that is desired.

The method comprises a step 210.

The step 210 comprises selecting a conformal box quantile \hat{q}_{B}^{k} for the k-th coordinate depending on the conformal label quantiles \hat{q}_{L}^{y}.

The step 210 may comprise selecting the largest of the conformal box coordinate quantiles \hat{q}_{B}^{k,y∈Ĉ}^{_{L}}^{(X}^{ₙ₊₁}⁾ over the classes y∈ [symbol] in the conformal label set Ĉ_{L}(Xₙ₊₁):

$${\hat{q}}_{B}^{k} = max {\{ {\hat{q}}_{B}^{k , y} \}}_{y ∈ {\overline{C}}_{L} ( {X}_{n + 1} ) ∀ k ∈ \{ 1 , … , m \}}$$

The conformal label setĈ_{L}(Xₙ₊₁) depends on the conformal label quantiles \hat{q}_{L}^{y}.

The method comprises a step 212.

The step 212 comprises determining a conformal box coordinate prediction interval for the k-th coordinate

$${\hat{C}}_{B}^{k} ( {X}_{n + 1} ) = [ {\hat{c}}_{n + 1}^{k} - {\hat{q}}_{B}^{k} , {\hat{c}}_{n + 1}^{k} + {\hat{q}}_{B}^{k} ] , k = 1 , … , m$$

depending on the conformal box quantile \hat{q}_{B}^{k} for the k-th coordinate.

The step 212 may comprise determining the prediction interval for the respective predicted coordinates.

The method may, in particular for checking whether an object detector \hat{f}(Xₙ₊₁) operates safely or not, comprise a step 214.

The step 214 comprises for example determining that the object detector \hat{f}(Xₙ₊₁) operates unsafely when the predicted coordinate is outside of the prediction interval.

The step 214 may comprise determining that the object detector \hat{f} operates safely when the predicted coordinates are within the prediction interval.

The step 214 may comprise determining that the object detector \hat{f} operates unsafely when the predicted coordinates are outside of the prediction interval.

The step 214 may comprise ignoring the bounding box coordinate or the bounding box coordinates for that an unsafe operation of the object detector \hat{f} is detected.

The method may comprise a step 216.

The step 216 may comprise operating the vehicle depending on the bounding box coordinates, when it is detected that the object detector \hat{f} operates safely, and otherwise not operating an in particular autonomous vehicle depending on the bounding box coordinates.

The step 216 may comprise operating the vehicle depending on the predicted classes, when it is detected that the object detector \hat{f} operates safely, and otherwise not operating an in particular autonomous vehicle depending on the bounding box coordinate or depending on the predicted class.

The step 216 for example comprises using the bounding box coordinates for that a safe operation of the object detector \hat{f} is detected to plan the trajectory.

The step 216 for example comprises operating the vehicle depending on the predicted classes, when it is detected that the object detector \hat{f} operates safely, and otherwise not operating the vehicle depending on the predicted class.

The step 216 for example comprises using the predicted class for that a safe operation of the object detector \hat{f} is detected to plan the trajectory.

The object's class labels l∈{1, . . . K} and the predicted label \hat{l}ₙ₊₁ for example indicate that an object is either to be avoided by the trajectory or can be driven over. The trajectory is for example planned to avoid the object in the bounding box identified by the predicted coordinates when the predicted class indicates that the object is to be avoided. The trajectory is for example planned to drive over the object in the bounding box identified by the predicted coordinates when the predicted class indicates that the object can be driven over.

FIG. 3 depicts a data structure (300), in particular a computer implemented data structure, characterized in that the data structure (300) comprises at least one data field (302) for calibration data, and for a test sample, wherein the calibration data comprises digital images that are associated with a respective ground truth bounding box coordinate and class label, wherein the test sample comprises a digital image, wherein the data structure comprises at least one data field (302) for a predicted box coordinate, for conformal label quantiles for the respective classes and conformal box coordinate quantiles for the respective box coordinates, for a conformal box coordinate quantile selected from the conformal box coordinate quantiles depending on the conformal label quantiles, and for a conformal box coordinate prediction interval.

The data structure (300) further comprises at least one data field (302) for a class associated with a respective digital image of the calibration data, preferably at least one data field (302) for a class associated with the digital image of the test sample, at least one data field (302) for a predicted class for the predicted box coordinate, for a conformal box coordinate quantile that is associated with a respective class of the set of classes, and for a conformal label set comprising a subset of the classes.

What is claimed is:

1. A method for determining a prediction interval for a coordinate of a bounding box, for checking whether an object detector operates safely or not, the method comprising the following steps:
providing calibration data and a test sample, wherein the calibration data includes digital images that are associated with a respective ground truth bounding box coordinate and class label, and wherein the test sample includes a digital image;
determining, using the object detector, a predicted box coordinate for the box coordinate depending on the digital image of the test sample;
determining, depending on the calibration data, conformal label quantiles for respective classes and conformal box coordinate quantiles for respective box coordinates;
selecting, depending on the conformal label quantiles, a conformal box coordinate quantile for the box coordinate from the conformal box coordinate quantiles for the respective box coordinates; and
determining the conformal box coordinate prediction interval for the box coordinate depending on the conformal box quantile for the box coordinate.

2. The method according to claim 1, wherein the selecting of the conformal box coordinate quantile for the box coordinate includes determining a conformal label set depending on the conformal label quantiles, wherein the conformal label set includes a subset of class labels of the calibration data, and selecting a largest of the conformal box coordinate quantiles over the classes in the conformal label set as the box coordinate quantile for the box coordinate.

3. The method according to claim 1, wherein the calibration data includes the digital images associated with a respective class of a set of classes, wherein the test sample includes the digital image associated with a class of the set of classes, and wherein the method further comprises:
determining, using the object detector, a predicted class for the predicted box coordinate, wherein the selecting of the conformal box coordinate quantile for the box coordinate includes determining, depending on the calibration data, for the classes in the set of classes a respective conformal box coordinate quantile that is associated with the respective class, determining, depending on the calibration data, a conformal label set including a subset of the classes, and selecting the largest of the conformal box coordinate quantiles that is associated to a class in the subset as the conformal box coordinate quantile for the box coordinate.

4. The method according to claim 3, wherein the determining of the conformal label set including the subset of the classes includes determining predicted class labels that are associated with a respective probability that the respective predicted class label labels correctly, determining for the classes in the set of classes, with a probabilistic classifier and a scoring function for the class, a respective conformal label quantile depending on the digital images of the calibration data, and selecting the subset in descending probability order from the predicted class labels such that a coverage according to the conformal label quantile is achieved.

5. The method according to claim 1, the method further comprising determining that the object detector operates unsafely when the predicted coordinate is outside of the prediction interval.

6. The method according to claim 1, further comprising:
determining, using the object detector, the predicted coordinates of the bounding box;
determining the prediction interval for the respective predicted coordinates; and
(i) determining that the object detector operates safely when the predicted coordinates are within the prediction interval, or (ii) determining that the object detector operates unsafely when the predicted coordinates are outside of the prediction interval.

7. The method according to claim 6, further comprising:
operating an autonomous vehicle depending on the bounding box coordinate, when it is detected that the object detector operates safely, and otherwise not operating the autonomous vehicle depending on the bounding box coordinate.

8. The method according to claim 6, further comprising:
operating an autonomous vehicle depending on the bounding box coordinate or depending on the predicted class, when it is detected that the object detector operates safely, and otherwise not operating the autonomous vehicle depending on the bounding box coordinate or depending on the predicted class.

9. A device configured to determine a prediction interval for a coordinate of a bounding box, for checking whether an object detector operates safely or not, the device comprising:
at least one processor; and
at least one memory, wherein the at least one memory is configured to store instructions that, when executed by the at least one processor cause the device to execute a method for determining a prediction interval for a coordinate of a bounding box, for checking whether an object detector operates safely or not, the method including the following steps:
providing calibration data and a test sample, wherein the calibration data includes digital images that are associated with a respective ground truth bounding box coordinate and class label, and wherein the test sample includes a digital image,
determining, using the object detector, a predicted box coordinate for the box coordinate depending on the digital image of the test sample,
determining, depending on the calibration data, conformal label quantiles for respective classes and conformal box coordinate quantiles for respective box coordinates,
selecting, depending on the conformal label quantiles, a conformal box coordinate quantile for the box coordinate from the conformal box coordinate quantiles for the respective box coordinates, and
determining the conformal box coordinate prediction interval for the box coordinate depending on the conformal box quantile for the box coordinate.

10. A non-transitory computer-readable medium on which is stored a computer program including computer readable instructions for determining a prediction interval for a coordinate of a bounding box, for checking whether an object detector operates safely or not, the instructions, when executed by a computer, causing the computer to perform the following steps:
providing calibration data and a test sample, wherein the calibration data includes digital images that are associated with a respective ground truth bounding box coordinate and class label, and wherein the test sample includes a digital image;
determining, using the object detector, a predicted box coordinate for the box coordinate depending on the digital image of the test sample;
determining, depending on the calibration data, conformal label quantiles for respective classes and conformal box coordinate quantiles for respective box coordinates;
selecting, depending on the conformal label quantiles, a conformal box coordinate quantile for the box coordinate from the conformal box coordinate quantiles for the respective box coordinates; and
determining the conformal box coordinate prediction interval for the box coordinate depending on the conformal box quantile for the box coordinate.

11. A computer implemented data structure, comprising:
at least one data field for calibration data, and for a test sample, wherein the calibration data includes digital images that are associated with a respective ground truth bounding box coordinate and class label, and the test sample includes a digital image; and
at least one data field for a predicted box coordinate, for conformal label quantiles for the respective classes, and conformal box coordinate quantiles for the respective box coordinates, for a conformal box coordinate quantile selected from the conformal box coordinate quantiles depending on the conformal label quantiles, and for a conformal box coordinate prediction interval.

12. The data structure according to claim 11, further comprising:
at least one data field for a class associated with a respective digital image of the calibration data;
at least one data field for a class associated with the digital image of the test sample; and
at least one data field for a predicted class for the predicted box coordinate, for a conformal box coordinate quantile that is associated with a respective class of the set of classes, and for a conformal label set including a subset of the classes.
